(19) United States
(12) Patent Application Publication
(10) Pub. No.: US 2020/0153509 A1
(43) Pub. Date: May 14, 2020

(54) OPTICAL WIRELESS UNIT, FREE SPACE OPTICAL WIRELESS CONTROL UNIT AND FREE SPACE WIRELESS CONTROL METHOD

(71) Applicant: INDUSTRIAL TECHNOLOGY RESEARCH INSTITUTE, Hsinchu (TW)

(72) Inventors: Ruei-Bin CHEN, Hsinchu City (TW); Chien-Hung YEH, Hsinchu City (TW); Ming-Chien TSENG, Zhubei City (TW)

(73) Assignee: INDUSTRIAL TECHNOLOGY RESEARCH INSTITUTE, Hsinchu (TW)

(21) Appl. No.: 16/231,665

(22) Filed: Dec. 24, 2018

(30) Foreign Application Priority Data
Nov. 9, 2018 (TW) 107139958

(51) Int. Cl. H04B 10/114; H04B 10/116; H04J 14/06

(52) U.S. Cl. CPC H04B 10/1143; H04B 10/532; H04J 14/06; H04B 10/116

(57) ABSTRACT

An optical wireless unit including an optical circulator, a collimator, and a lens is provided. The collimator is configured to receive an optical signal via a first port of the optical circulator. The collimator is coupled with a second port of the optical circulator and is configured to transmit the optical signal into air to form a first free space optical wireless signal. The lens is coupled with the collimator and a third port of the optical circulator and is configured to receive and focus a second free space optical wireless signal to the collimator. The first free space optical wireless signal has a wavelength λ₀, the second free space optical wireless signal has a wavelength λ_{N}, and N is a positive integer.

This application claims the benefit of Taiwan application Serial No. 107139958, filed Nov. 9, 2018, the subject matter of which is incorporated herein by reference.

### TECHNICAL FIELD

The present disclosure relates in general to an optical wireless unit and a method based on free space optical wireless communication.

### BACKGROUND

The large-capacity broadband access network technology uses Passive Optical Network (PON) architecture as the main network. The conventional PON architecture is subjected to geographical constraints, and the optical fiber may not be connected if the environment does not allow. For example, when the uploading/downloading transmission is performed on a mobile carrier, such as on a train moving at a high speed or along the rail side, the configuration of PON will become more difficult and more expensive.

Conventionally, each ground station is a terminal of the PON, and after the signal is processed with photoelectric conversion, wireless communication is performed using transmission antenna and carrier. Such design not only increases system cost, but further increases the complexity in system transmission.

Therefore, how to reduce the difficulty and cost in the configuration of PON and to reduce the terminal cost of the PON system and the complexity in system transmission has become a prominent task for the industries.

### SUMMARY

According to an embodiment of the present disclosure, an optical wireless unit including an optical circulator, a collimator, and a lens is provided. The collimator is configured to receive an optical signal via a first port of the optical circulator. The collimator is coupled with a second port of the optical circulator and is configured to transmit the optical signal into the air to form a first free space optical wireless signal. The lens is coupled with the collimator and a third port of the optical circulator and is configured to receive and focus a second free space optical wireless signal to the collimator. The first free space optical wireless signal has a wavelength λ₀, the second free space optical wireless signal has a wavelength λ_{N}, and N is a positive integer.

According to another embodiment of the present disclosure, a free space optical wireless control unit including a head end and at least one ground unit is provided. The head end includes a laser diode, an optical circulator, and a wavelength division multiplexer. The laser diode is configured to generate an optical signal. The optical circulator is configured to receive the optical signal via a first port of the optical circulator. The wavelength division multiplexer is coupled with a third port of the optical circulator and is configured to receive a second free space optical wireless signal via a second port of the optical circulator. The at least one ground unit includes an optical circulator and a lens. The optical circulator is configured to receive the optical signal via the first port of the optical circulator and to transmit the optical signal into the air via the second port to form a first free space optical wireless signal. The lens is coupled with the third port and is configured to receive the second free space optical wireless signal. The first free space optical wireless signal has a wavelength λ₀, the second free space optical wireless signal has a wavelength λ_{N}, and N is a positive integer.

According to an alternate embodiment of the present disclosure, a free space optical wireless control method is provided. The free space optical wireless control method includes the following steps: forming a first free space optical wireless signal having a wavelength λ₀; transmitting the first free space optical wireless signal into air by an optical splitter; receiving and transmitting a second free space optical wireless signal to an optical circulator by a lens, wherein the second free space optical wireless signal has a wavelength λ_{N}, and N is a positive integer.

The above and other aspects of the present disclosure will become better understood with regard to the following detailed description of the preferred but non-limiting embodiment(s). The following description is made with reference to the accompanying drawings.

### BRIEF DESCRIPTION OF THE DRAWINGS

FIGS. 1A to 1B are schematic diagrams of an optical wireless unit.

FIG. 2 is a schematic diagram of a free space optical wireless control unit.

FIG. 3 is an experimental architecture diagram of a free space optical wireless communication.

FIG. 4 is a schematic diagram of bit error rates and power sensitivities of free space optical wireless signal transmitted through a 25 km of optical fiber according to an embodiment of the present disclosure.

FIG. 5A is an architecture diagram of a simulated optical system according to an embodiment of the present disclosure.

FIG. 5B is a power output diagram of a free space optical wireless communication optical power within a wireless transmission distance of 0 to 500 m according to an embodiment of the present disclosure.

FIG. 6 is a flowchart of a free space optical wireless control method.

FIG. 7 is a schematic diagram of another free space optical wireless control method.

FIG. 8 is Table 1 and Table 2.

### DETAILED DESCRIPTION

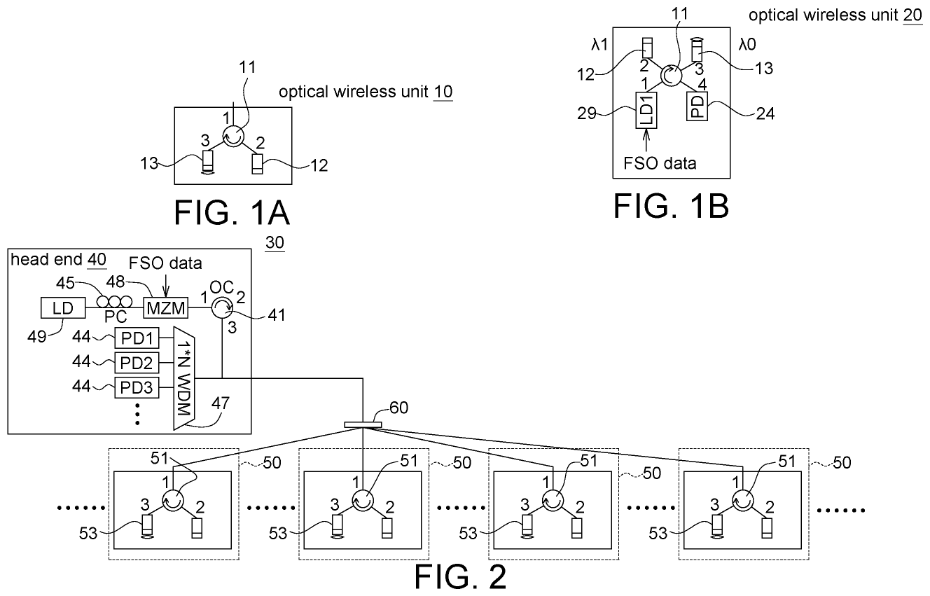

FIGS. 1A to 1B are schematic diagrams of an optical wireless unit. According to an embodiment of the optical wireless unit of the present disclosure, the optical wireless unit 10 of FIG. 1A includes an Optical Circulator (OC) 11, a Collimator (COL) 12 and a lens 13. The optical wireless unit 10 is configured to receive an optical signal via a first port of the optical circulator 11. The optical signal includes data of free space optical wireless signal being any electric signal. The collimator 12 is configured to transmit the optical signal into the air via a second port of the optical circulator 11 to form a first free space optical wireless signal, which is transmitted by way of broadcasting (that is, power sharing). The lens 13 is coupled with a third port of the optical circulator 11 and the collimator 12 and is configured to receive and focus a second free space optical wireless signal to the collimator 12. The second free space optical wireless signal is transmitted by way of wavelength division multiplexing.

The first free space optical wireless signal has a fixed wavelength λ₀, the second free space optical wireless signal has a wavelength λ_{N}, N is a positive integer, and the N wavelengths are all different. The first free space optical wireless signal and the second free space optical wireless signal both belong to C-band or L-band, such that the dispersion phenomenon which occurs when the first free space optical wireless signal and the second free space optical wireless signal pass through an optical fiber can be reduced. However, the present disclosure is not limited thereto. The optical wireless unit 10 of the present disclosure performs bi-directional single mode transmission.

According to another embodiment of the optical wireless unit of the present disclosure, the optical circulator 11 of the optical wireless unit 20 of FIG. 1B further includes a fourth port coupled with a photodiode (PD) 24. The photodiode 24 is configured to receive and demodulate the first free space optical wireless signal to an electric signal. The present embodiment is an embodiment of a remote end optical wireless unit. However, the present disclosure is not limited thereto. The optical wireless unit 20 of the present disclosure performs bi-directional single mode transmission.

According to another embodiment of the optical wireless unit of the present disclosure, the first port of the optical circulator 11 of the optical wireless unit 20 is coupled with a laser diode 29, and the optical signal includes data of free space optical wireless signal being any electric signal.

FIG. 2 is a schematic diagram of a free space optical wireless control unit. The free space optical wireless control unit 30 of FIG. 2 includes a head end 40 and at least one ground unit 50.

The head end 40 includes an optical circulator 41, a laser diode 49, and a wavelength division multiplexer 47. The laser diode 49 is configured to generate an optical signal. However, the present disclosure is not limited thereto. The optical circulator 41 is configured to receive the optical signal via a first port of the optical circulator 41, wherein the optical signal includes data of free space optical wireless signal being any electric signal. The wavelength division multiplexer 47 is coupled with a third port of the optical circulator 41 and is configured to receive a second free space optical wireless signal via a second port of the optical circulator 41, wherein the second free space optical wireless signal has a wavelength λ_{N}, N is a positive integer, and the wavelengths λ₁ to λ_{N} are all different. In an embodiment, the laser diode 49 is coupled with a Mach-Zehnder Modulator (MZM) 48 configured to demodulate the electric signal in the optical signal. The wavelength division multiplexer 47 is configured to receive and distribute the second free space optical wireless signal to corresponding photodiodes 44 according to the wavelengths. The photodiodes 44 are configured to receive and demodulate the optical signal of the second free space optical wireless signal λ₁ to λ_{N}. The Polarization Controller (PC) 45 is configured to control the polarization state of the optical path to maximize the power output of the laser diode 49.

The at least one ground unit 50 includes an optical circulator 51 and a lens 53. The optical circulator 51 is configured to receive an optical signal via a first port of the optical circulator 51. The optical circulator 51 is configured to transmit the optical signal into the air via a second port of the optical circulator 51 to form a first free space optical wireless signal, which is transmitted by way of broadcasting. The lens 53 is coupled with a third port of the optical circulator 51 and is configured to receive a second free space optical wireless signal, which is transmitted by way of wavelength division multiplexing. The first free space optical wireless signal has a fixed wavelength λ₀. The first free space optical wireless signal and the second free space optical wireless signal both belong to C-band or L-band. The at least one ground unit is a base station or an apparatus including an optical wireless unit. However, the present disclosure is not limited thereto.

According to an embodiment of the free space optical wireless control unit of the present disclosure, the free space optical wireless control unit 30 further includes an optical splitter 60, which broadcasts the optical signal to a remote end optical wireless unit by way of power sharing. The remote end optical wireless unit is disposed on a mobile carrier, which can be realized by a transportation, such as a train or a train compartment moving at a high speed. However, the present disclosure is not limited thereto. Each train or train compartment has a fixed wavelength λ_{N}, the wavelengths λ₁ to λ_{N} are all different, and N is the number of trains or train compartments, such that the signals will not collide or interfere with each other. Since the trains or train compartments communicate with the same head end 40, there is no change-hand problem. The free space optical wireless control unit 30 and the remote end optical wireless unit both use air as a transmission medium. The head end 40 is configured to transmit the first free space optical wireless signal to the remote end optical wireless unit through a Single Mode Fiber (SMF) and the optical splitter 60.

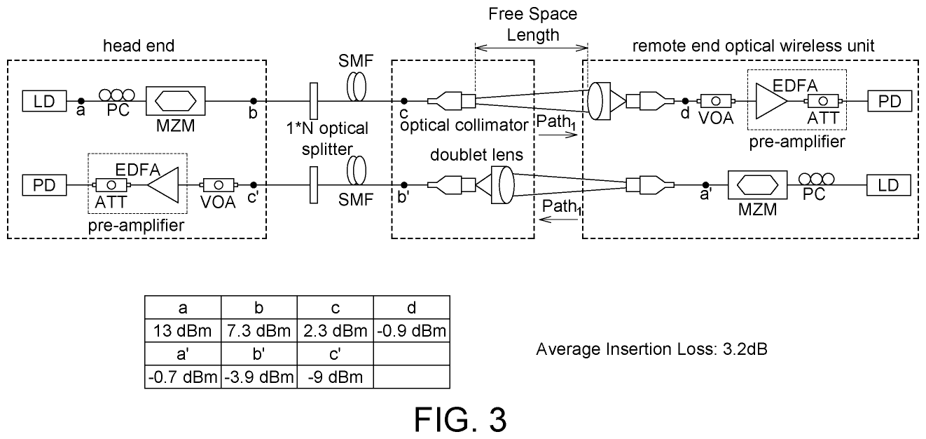

Then, the total number of the at least one ground unit is calculated. FIG. 3 is an experimental architecture diagram of free space optical wireless communication. FIG. 3 is an experimental architecture diagram of an FSO-PON communication system. In regard to the downloading transmission of the free space optical wireless signal, the head end uses the laser diode as a light source. However, the present disclosure is not limited thereto. The laser diode is connected to a polarization controller and a 10 GHz Mach-Zehnder modulator. After having been transmitted through 25 km of single mode fiber, the free space optical wireless signal is then connected to a fiber-optic collimating mirror of the optical wireless unit. The fiber-optic collimating mirror has a divergence angle of about 0.016°. The lens of the fiber-optic collimating mirror has a diameter of about 20 mm and a focal length of about 37.13 mm. In the experiment, the free space transmission length is set as 6 m, and the free space optical wireless signal is focused by a doublet lens having a diameter of 50 mm and a focal length of 75 mm and is coupled to the collimating mirror of a remote end optical wireless unit. Lastly, the downloaded optical signal of the free space optical wireless signal can be received and demodulated by a 10 GHz PIN-Photodiode (PIN-PD).

As indicated in FIG. 3, after point d, a Variable Optical Attenuator (VOA) is configured not only to measure the efficiency of Bit Error Rate (BER) and the sensitivity of optical power but also to simulate the maximum splitting ratio and the minimum splitting ratio of a 1×M Optical Splitter (OS). In the present experiment, the power levels measured at points “a”, “b” and “c”, point d, and points “a′”, “b′” and “c′” respectively are: a=13 dBm, b=7.3 dBm, c=2.3 dBm, d=−0.9 dBm, a′=−0.7 dBm, b′=−3.9 dBm, c′=−9 dBm. Besides, a pre-amplifier module can be disposed at the head end and the remote end optical wireless unit to amplify and optimize the free space optical wireless signal. The pre-amplifier module is formed of an Erbium-Doped Fiber Amplifier (EDFA) and an Attenuator (ATT). Similarly, the uploading path of the free space optical wireless signal is illustrated in the architecture diagram of FIG. 3.

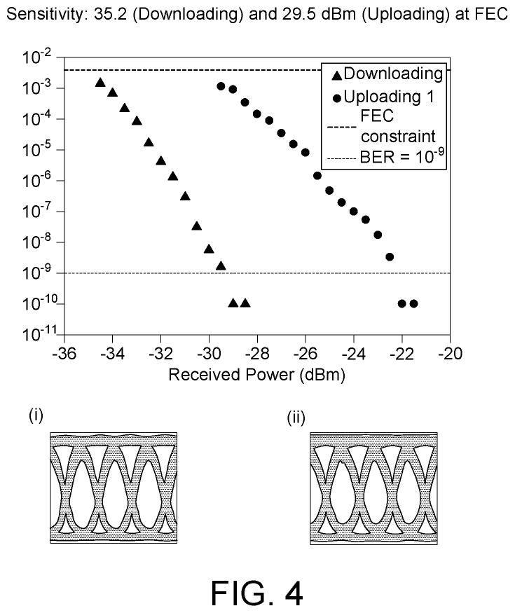

Referring to FIG. 4, a schematic diagram of bit error rates and power sensitivities of free space optical wireless signal transmitted through 25 km of optical fiber according to an embodiment of the present disclosure is shown. FIG. 4 illustrates the efficiency of bit error rate of a free space optical wireless signal uploaded or downloaded through 25 km of single mode fiber and 6 m of free space at different optical power levels. In the present experiment, the laser diode emits an optical power of 7.3 dBm. The sensitivities of the optical power of the downloaded and the uploaded free space optical wireless signal measured by the photodiode at a Forward Error Correction (FEC) position (BER=3.8×10⁻³) after 5 km of single mode fiber and 6 m of free space are 35.2 dBm and 29.5 dBm respectively. Furthermore, the illustrations (i) and (ii) of FIG. 4 are eye diagrams of the spectrogram of the downloading/uploading transmission of the free space optical wireless signal at BER=1×10⁻⁹. The experimental results of FIG. 4 show that the maximum allowable optical power budget of the downloading/uploading transmission of the free space optical wireless signal can reach 42.5 dB and 36.8 dB respectively.

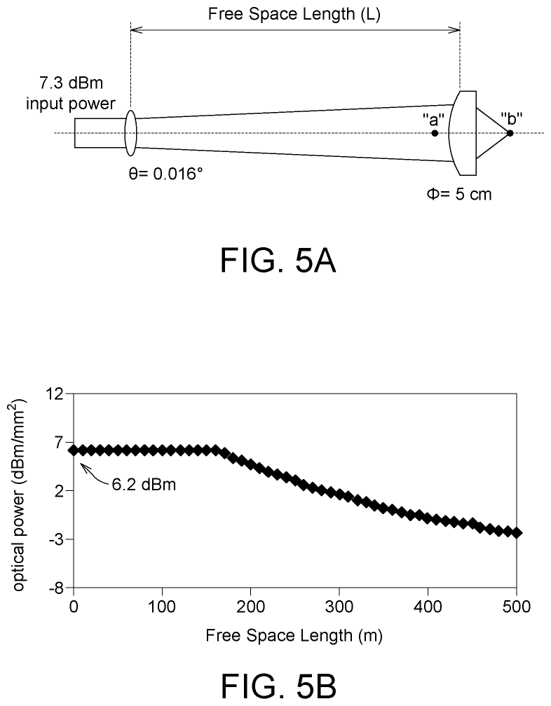

To confirm the transmission distance that an optical wireless system can achieve in a free space, an optical simulation software TracePro can be used to simulate the transmission distance of the optical wireless signal in a free space. FIG. 5A is an architecture diagram of a simulated optical system according to an embodiment of the present disclosure. All simulated optical parameters are actual parameters used in the experiment. Similarly, after the free space optical wireless signal having an input power of 7.3 dBm enters the collimating mirror, the free space optical wireless signal is outputted at a divergent angle of 0.016°, and is then collected and focused at point “b” by a doublet lens at the reception end as indicated in FIG. 5A. Therefore, for each free space length (L), the optical power obtained at the focal point “b” is different. FIG. 5B shows the optical power of the free space optical wireless signal obtained at point “b” when the free space transmission length is between 0 to 500 m. As indicated in FIG. 5B, the optical power obtained at a free space transmission length of 160 m is about 6.2 dBm/mm2 and almost remains the same within the length of 160 m, and has an optical attenuation of about 1.1 dB. As the transmission length in free space optical wireless communication increases, the diameter of the laser beam also increases, the optical power diverges, and the optical power detected 160 m after starts to decrease due to the atmospheric absorption effect. FIG. 5B shows that when the transmission length in free space optical wireless communication is 250 m, 350 m and 500 m respectively, the power loss caused by the divergence and absorption of the laser optical power is 4.2 dB, 7.0 dB and 9.6 dB, respectively.

Based on the above experiment and simulated result, in an ideal transmission state of free space optical wireless communication, the optical power budget is 42.5 dB, and the total loss is calculated as: Total Loss=atmospheric and divergent loss+optical fiber path loss+coupling optical attenuation+optical splitter loss+other optical element loss. Meanwhile, the cabled optical fiber can transmit the optical wireless signal up to 25 km (the optical attenuation is about 5 dB), the air channel can transmit the optical wireless signal up to 160 m (the optical attenuation is about 1.1 dB). Under the budge constraint, a 1×2048 optical splitter (the power loss is about 33 dB) is used. Since the optical path insertion loss is about 3.2 dB, the total power loss of the free space optical wireless system of 1×2048 optical wireless units through a transmission distance of 25 km of single mode fiber and 160 m of air channel is 42.3 dB. According to an embodiment of a free space optical wireless control unit of the present disclosure, the splitting ratio of the optical splitter 60 is determined according to the power budget of the optical link between the first free space optical wireless signal and the second free space optical wireless signal.

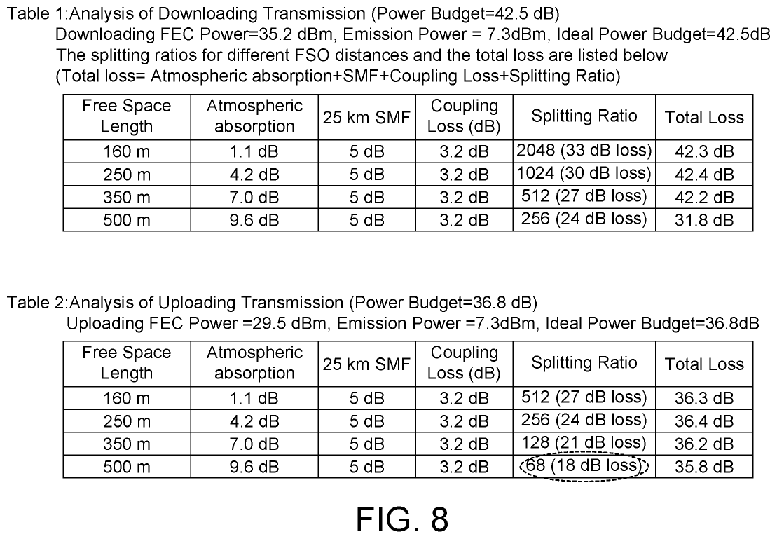

The splitting ratios for 25 km of single mode fiber and different lengths of air channel are illustrated in Table 1 and Table 2 of FIG. 8. If the air channel needs to reach 500 m, the maximum splitting ratio of the downloading transmission in free space optical wireless communication is 256 (Table 1), and the maximum splitting ratio of the downloading transmission in free space optical wireless communication is 68 (Table 2). Therefore, when the overall uploading/downloading transmission in free space optical wireless communication reaches 500 m, the free space optical wireless system can only provide 68 optical wireless units moving at a high speed for the free space optical wireless communication. According to an embodiment of a free space optical wireless control unit of the present disclosure, the number of the at least one ground unit 50 is determined according to the splitting ratio, and the coverage of the free space optical wireless control unit 30 is determined according to the number of the at least one ground unit 50.

Based on the design of the free space optical wireless system, the volume of the optical power outputted by the optical wireless unit in free space optical wireless communication and can be received by the train is relevant with the transmission length of optical fiber, the number of optical wireless units and the transmission length of air channel in free space optical wireless communication. FIG. 2 shows that the total number of optical wireless units is determined according to the splitting ratio of the 1×M optical splitters. However, the present disclosure is not limited thereto.

The total number of optical wireless units is estimated according to the total optical power budget of the entire communication system in terms of the downloading transmission in free space optical wireless communication. The downloading transmission of signals will have power loss and absorption, such as the absorption loss over the total transmission length of optical fiber, the loss caused by each photo-electronic element, and the ambient loss in a free space (such as atmospheric absorption, fogs, rains, and so on, but the present disclosure is not limited thereto).

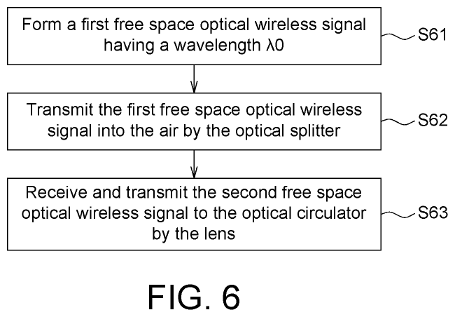

Referring to FIG. 6, a flowchart of a free space optical wireless control method is shown. The free space optical wireless control method of the present disclosure includes the following steps: In step S61, a first free space optical wireless signal is formed, wherein the first free space optical wireless signal has a fixed wavelength λ₀. In step S62, the first free space optical wireless signal is transmitted into the air by an optical splitter 60. In step S63, a second free space optical wireless signal is received and transmitted to the optical circulator 51 by the lens, wherein the second free space optical wireless signal has a wavelength λ_{N}, N is a positive integer, and the N wavelengths are all different.

According to the free space optical wireless control method, the first free space optical wireless signal is transmitted into the air by the optical splitter 60 by way of broadcasting, and the second free space optical wireless signal is transmitted by way of wavelength division multiplexing. The first free space optical wireless signal and the second free space optical wireless signal both belong to C-band or L-band. The first free space optical wireless signal and the second free space optical wireless signal include data of free space optical wireless signal being any electric signal.

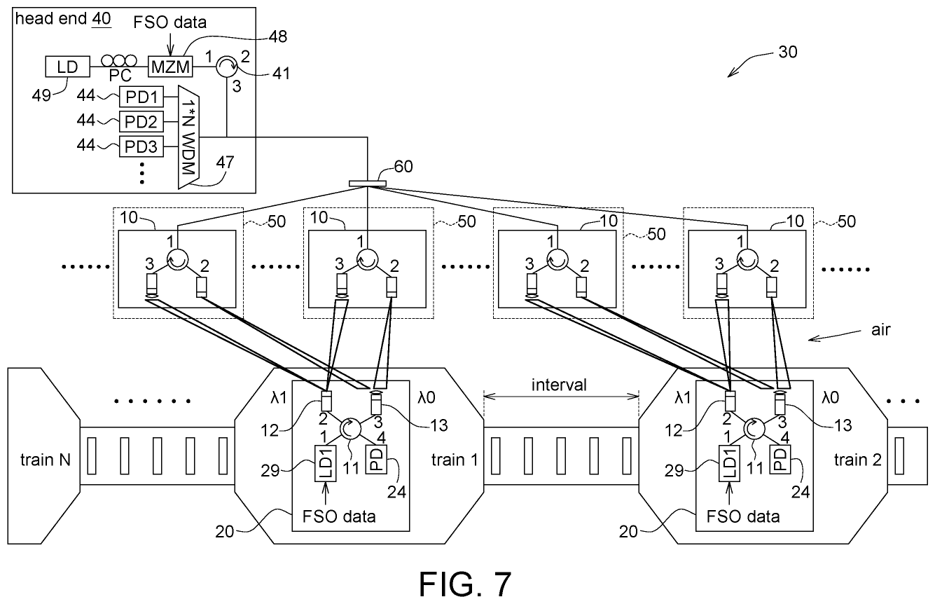

Referring to FIG. 7, a schematic diagram of another free space optical wireless control method is shown. An embodiment of a free space optical wireless control method of the present disclosure includes the following steps. Firstly, an optical signal is generated by the laser diode 49 at the head end 40. Then, the optical signal is modulated (the optical signal includes data of free space optical wireless signal). For example, the optical signal is demodulated to an electric signal by a Mach-Zehnder modulator 48, but the present disclosure is not limited thereto. Then, the optical signal is transmitted to the second port from the first port of the optical circulator 41 to be broadcasted and transmitted through a single mode fiber. Then, the optical signal is transmitted to at least one ground unit 50 by the optical splitter 60 through the single mode fiber. Then, a first free space optical wireless signal is transmitted to the air by the optical wireless unit 10 disposed on the at least one ground unit 50, wherein the first free space optical wireless signal has a wavelength λ₀. The dispersed light is focused to the collimator 12 by the lens 13 of the remote end optical wireless unit 20 (disposed on the mobile carrier) and is then coupled with the wireless optical signal in the air and transmitted to the optical fiber. Then, the optical signal is transmitted to the fourth port from the third port of the optical circulator. The first free space optical wireless signal is received and demodulated to an electric signal by the photodiode 24. The optical wireless unit 10 disposed on at least one ground unit 50 does not need to process the conversion of photo-electric signal.

Referring to FIG. 7, a flowchart of a free space optical wireless control method according to another embodiment of the present disclosure is shown. An optical signal is generated by the laser diode 29 of the remote end optical wireless unit 20 disposed on the mobile carrier, wherein the optical signal includes data of free space optical wireless signal being any electric signal. The optical signal on the mobile carrier has different wavelengths λ_{N} and is transmitted by way of wavelength division multiplexing without colliding or interfering with the second free space optical wireless signal transmitted into the air. A second free space optical wireless signal is received and focused by the lens 13 of the optical wireless unit 10 disposed on the at least one ground unit 50. The second free space optical wireless signal is transmitted to the first port from the third port of the optical circulator 11 and is then transmitted to the same head end 40 through the single mode fiber. Therefore, there is no change-hand problem. Then, the second free space optical wireless signal is transmitted to the third port from the second port of the optical circulator 41 at the head end 40. Then, the second free space optical wireless signal is received by the wavelength division multiplexer 47, and the second free space optical wireless signals λ₁ to λ_{N} are received and demodulated to an electric signal by corresponding photodiodes 44. The optical wireless unit 10 disposed on the at least one ground unit 50 does not need to process the conversion of photo-electric signal.

To summarize, the reception end of the passive optical network (PON) of the present disclosure can replace some difficult configuration of optical fiber network and location arrangement with the transmission in free space optical wireless communication, but the present disclosure is not limited thereto. For example, at a train moving at a high speed, the uploading/downloading transmission is performed using integrated Free-Space Optical/Passive Optical Networks (FSO-PON) technology. In regard to the free space optical wireless communication, given that the bit error rate BER is under the FEC constraint, a corresponding relationship exists between the length of single mode fiber and the splitting ratio of optical splitter, and the number of the at least one ground unit can be determined according to the corresponding relationship. The power loss of optical signal caused by atmospheric absorption at different transmission distances between the optical wireless unit and the remote end optical wireless unit can be used as a reference for optimizing the system design of the FSO-PON optical fiber network. At least one ground unit of the present disclosure does not need to process the conversion of photo-electric signal. Since all elements are passive elements and no transceiver element is used, the architecture is simple and the cost is cheap.

While the present disclosure has been described by way of example and in terms of the preferred embodiment(s), it is to be understood that the present disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An optical wireless unit, comprising:
an optical circulator configured to receive an optical signal via a first port of the optical circulator;
a collimator coupled with a second port of the optical circulator and configured to transmit the optical signal into air to form a first free space optical wireless signal; and
a lens coupled with the collimator and a third port of the optical circulator and configured to receive and focus a second free space optical wireless signal to the collimator;
wherein the first free space optical wireless signal has a wavelength λ₀, the second free space optical wireless signal has a wavelength λ_{N}, and N is a positive integer.

2. The optical wireless unit according to claim 1, wherein the optical circulator further has a fourth port coupled with a photodiode.

3. The optical wireless unit according to claim 2, wherein the photodiode is configured to receive and demodulate the first free space optical wireless signal to an electric signal.

4. The optical wireless unit according to claim 1, wherein the second free space optical wireless signal is transmitted by way of wavelength division multiplexing.

5. The optical wireless unit according to claim 1, wherein the first free space optical wireless signal is transmitted by way of broadcasting.

6. The optical wireless unit according to claim 1, wherein the first free space optical wireless signal and the second free space optical wireless signal both belong to C-band or L-band.

7. The optical wireless unit according to claim 1, wherein the optical signal comprises data of free space optical wireless signal being any electric signal.

8. The optical wireless unit according to claim 1, wherein the optical wireless unit performs bi-directional single mode transmission.

9. The optical wireless unit according to claim 1, wherein the wavelengths λ₁ to λ_{N} are all different.

10. A free space optical wireless control unit, comprising:
a head end, comprising:
a laser diode configured to generate an optical signal;
an optical circulator configured to receive the optical signal via a first port of the optical circulator;
a wavelength division multiplexer coupled with a third port of the optical circulator and configured to receive a second free space optical wireless signal via a second port of the optical circulator; and
at least one ground unit, comprising:
an optical circulator configured to receive the optical signal via the first port of the optical circulator and to transmit the optical signal into air via the second port of the optical circulator to form a first free space optical wireless signal; and
a lens coupled with the third port and configured to receive the second free space optical wireless signal;
wherein the first free space optical wireless signal has a wavelength λ₀, the second free space optical wireless signal has a wavelength λ_{N}, and N is a positive integer.

11. The free space optical wireless control unit according to claim 10, wherein the laser diode is coupled with a Mach-Zehnder modulator, which is configured to demodulate an electric signal in the optical signal.

12. The free space optical wireless control unit according to claim 10, further comprising an optical splitter, which broadcasts the optical signal to a remote end optical wireless unit by way of power sharing.

13. The free space optical wireless control unit according to claim 12, wherein a splitting ratio of the optical splitter is determined according to a power budget of an optical link between the first free space optical wireless signal and the second free space optical wireless signal.

14. The free space optical wireless control unit according to claim 12, wherein a number of the at least one ground unit is determined according to the splitting ratio.

15. The free space optical wireless control unit according to claim 12, wherein a coverage of the free space optical wireless control unit is determined according to the splitting ratio.

16. The free space optical wireless control unit according to claim 12, wherein the remote end optical wireless unit is disposed on a mobile carrier.

17. The free space optical wireless control unit according to claim 16, wherein the mobile carrier is a transportation.

18. The free space optical wireless control unit according to claim 10, wherein the wavelength division multiplexer is configured to receive the second free space optical wireless signal, and distributes the second free space optical wireless signal to corresponding photodiode according to the wavelength of the second free space optical wireless signal.

19. The free space optical wireless control unit according to claim 18, wherein the photodiode is configured to receive and demodulate the second free space optical wireless signals λ₁ to λ_{N}.

20. The free space optical wireless control unit according to claim 12, wherein the free space optical wireless control unit and the remote end optical wireless unit use air as a transmission medium.

21. The free space optical wireless control unit according to claim 12, wherein the at least one optical wireless unit and the optical splitter use an optical fiber as a transmission medium.

22. The free space optical wireless control unit according to claim 10, wherein the second free space optical wireless signal is transmitted by way of wavelength division multiplexing.

23. The free space optical wireless control unit according to claim 10, wherein the first free space optical wireless signal and the second free space optical wireless signal both belong to C-band or L-band.

24. The free space optical wireless control unit according to claim 10, wherein the optical signal comprises data of free space optical wireless signal being any electric signal.

25. The free space optical wireless control unit according to claim 10, wherein the at least one ground unit is a base station or an apparatus comprising an optical wireless unit.

26. The free space optical wireless control unit according to claim 12, wherein the head end is configured to transmit the first free space optical wireless signal to the remote end optical wireless unit through a single mode fiber and the optical splitter.

27. The free space optical wireless control unit according to claim 10, further comprising polarization controller configured to control a polarization state of an optical path to maximize a power output of the laser diode.

28. The free space optical wireless control unit according to claim 10, wherein the at least one ground unit performs bi-directional single mode transmission.

29. The free space optical wireless control unit according to claim 10, wherein the wavelengths λ₁ to λ_{N} are all different.

30. A free space optical wireless control method, wherein the free space optical wireless control method comprises:
forming a first free space optical wireless signal having a wavelength λ₀;
transmitting the first free space optical wireless signal into air by an optical splitter; and
receiving and transmitting a second free space optical wireless signal to an optical circulator by a lens;
wherein the second free space optical wireless signal has a wavelength λ_{N}, and N is a positive integer.

31. The free space optical wireless control method according to claim 30, wherein the first free space optical wireless signal is transmitted into air by way of broadcasting.

32. The free space optical wireless control method according to claim 30, wherein the second free space optical wireless signal is transmitted by way of wavelength division multiplexing.

33. The free space optical wireless control method according to claim 30, wherein the first free space optical wireless signal and the second free space optical wireless signal both belong to C-band or L-band.

34. The free space optical wireless control method according to claim 30, wherein the first free space optical wireless signal and the second free space optical wireless signal both comprise data of free space optical wireless signal being any electric signal.

35. The free space optical wireless control method according to claim 30, wherein the wavelengths λ₁ to λ_{N} are all different.
